(19) United States
(12) Patent Application Publication
(10) Pub. No.: US 2026/0287830 A1
(43) Pub. Date: Sep. 24, 2026

(54) CO-PACKAGED OPTICS STRUCTURE WITH OPTICAL CONNECTORS HAVING WAVEGUIDE STRESS RELIEF FEATURES

(71) Applicant: International Business Machines Corporation, Armonk, NY (US)

(72) Inventors: Chinami Ishikawa, Yokohama-city (JP); Akihiro Horibe, Yokohama (JP); Sayuri Hada, Machida-shi (JP)

(21) Appl. No.: 19/088,350

(22) Filed: Mar. 24, 2025

(51) Int. Cl. G02B 6/38; G02B 6/42; G02B 6/44

(52) U.S. Cl. CPC G02B 6/3889; G02B 6/3854; G02B 6/424; G02B 6/426; G02B 6/4403

(57) ABSTRACT

A connector structure for coupling optical signals to a semiconductor device includes a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, and a lid positioned over the optical waveguide structure, the lid securing the optical waveguide structure in the recessed portion of the connector body, the lid having a first edge and a second edge, the first edge of the lid being proximate to the first side of the connector body, the second edge of the lid being offset from an edge at the second side of the connector body.

### BACKGROUND

The present application relates to packaging techniques for photonics applications, and more specifically, to connectors utilized for integrating photonics device with electrical components in co-packaged optics (CPO).

Photonics devices and applications are configured for performing various functions that involve light. Such functions include, but are not limited to, generating, emitting, transmitting, modulating, signal processing, amplifying and detecting or sensing light within visible and near-infrared portions of the electromagnetic spectrum. CPO techniques may be leveraged for implementing photonics applications. CPO techniques, for example, include co-fabricating optoelectronic devices or photonic devices with complementary metal-oxide-semiconductor (CMOS) integrated circuits to implement photonics systems. Photonics applications, however, may also be fabricated without integrated CMOS circuitry, though the lack of integrated CMOS circuitry does not provide CMOS functions and thus lack analog and digital on-chip controls.

Computer system performance may be measured by system availability, speed of computation, processor speed, etc. Communication or network bandwidth between computers and between components within a computer can also contribute to a computer system's overall performance. Computer systems may include multi-core processors and multiple processors per machine, including combination of central processing units (CPUs) and one or more graphical processing units (GPUs), requiring an increase in communication therebetween and between such processor units their associated memory. Electrical data links perform best over relatively short distances, and reach performance limits as the link distance and frequency increases. Optical data links over fiber are capable of high-speed communications with low loss over larger distances than electrical data links. Co-packaged optics solutions may be leveraged to obtain such benefits in combination with the use of electrical components in integrated circuits.

### SUMMARY

Embodiments of the invention provide techniques for forming co-packaged optics structures with optical connectors having waveguide stress relief features.

In one embodiment, a connector structure for coupling optical signals to a semiconductor device includes a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, and a lid positioned over the optical waveguide structure, the lid securing the optical waveguide structure in the recessed portion of the connector body, the lid having a first edge and a second edge, the first edge of the lid being proximate to the first side of the connector body, the second edge of the lid being offset from an edge at the second side of the connector body.

In another embodiment, a connector structure for coupling optical signals to a semiconductor device includes a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, a lid positioned over the optical waveguide structure, the lid securing the optical waveguide structure in the recessed portion of the connector body, the lid having a first edge and a second edge, the first edge of the lid being proximate to the first side of the connector body, the second edge of the lid being proximate to the second side of the connector body, and a support structure attached along an intersection line of the optical waveguide structure and the second edge of the lid.

In another embodiment, a CPO structure includes a semiconductor device having an optical IO port and a connector structure coupling an optical waveguide structure to the optical IO port of the semiconductor device, the connector structure including a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, and a lid positioned over the optical waveguide structure, the lid securing the optical waveguide structure in the recessed portion of the connector body. At least one of: the lid has a first edge and a second edge, the first edge of the lid being proximate to the first side of the connector body, the second edge of the lid being offset from an edge at the second side of the connector body; and the connector structure further comprises a support structure attached along an intersection line of the optical waveguide structure and the second edge of the lid.

### BRIEF DESCRIPTION OF THE DRAWINGS

FIGS. 1A-1C show views of a co-packaged optics structure including a connector for an optical waveguide, the connector having a lid over the optical waveguide with a recessed edge, according to an embodiment of the invention.

FIGS. 2A-2C show views of a co-packaged optics structure including a connector for an optical waveguide, the connector having a lid over the optical waveguide and including a protrusion extending past an edge of the lid supporting the optical waveguide, according to an embodiment of the invention.

FIGS. 3A-3C show views of a co-packaged optics structure including a connector for an optical waveguide, the connector having a lid over the optical waveguide and a support resin extending over an interface of the lid and the optical waveguide, according to an embodiment of the invention.

FIGS. 4A-4C illustrate a process for formation of a co-packaged optics structure including a connector for an optical waveguide, the connector having a lid over the optical waveguide with a recessed edge, according to an embodiment of the invention.

FIGS. 5A-5C illustrates a process for formation of a co-packaged optics structure including a connector for an optical waveguide, the connector having a lid over the optical waveguide and a support resin extending over an interface of the lid and the optical waveguide, according to an embodiment of the invention.

FIG. 6 shows a view of a co-packaged optics structure including a connector for stacked optical waveguides, the connector having a lid over an uppermost one of the stacked optical waveguides with a recessed edge, according to an embodiment of the invention.

FIG. 7 shows a view of a co-packaged optics structure including a connector for stacked optical waveguides, the connector having a lid over an uppermost one of the stacked optical waveguides and including a protrusion extending past an edge of the lid supporting the uppermost one of the stacked optical waveguides, according to an embodiment of the invention.

FIG. 8 shows a view of a co-packaged optics structure including a connector for stacked optical waveguide structures, the connector having a lid over an uppermost one of the stacked waveguides and a support resin extending over an interface of the lid and the uppermost one of the stacked waveguides, according to an embodiment of the invention.

FIGS. 9A-9E show respective views and stress plots for a co-packaged optics structure including a connector for an optical waveguide, the connector having a lid over the optical waveguide with a recessed edge, according to an embodiment of the invention.

FIGS. 10A-10F show respective views and stress plots for a co-packaged optics structure including a connector for an optical waveguide, the connector having a lid over the optical waveguide and a support resin extending over an interface of the lid and the optical waveguide, according to an embodiment of the invention.

FIG. 11 shows a photonics system having a co-packaged optics structure with one or more waveguide stress relief features coupling an optical fiber to a silicon-based photonics device, according to an embodiment of the invention.

FIG. 12 shows an integrated circuit comprising one or more co-packaged optics structures with one or more waveguide stress relief features, according to an embodiment of the invention.

### DETAILED DESCRIPTION

Illustrative embodiments of the invention may be described herein in the context of illustrative methods for forming co-packaged optics structures with optical connectors having waveguide stress relief features, along with illustrative apparatus, systems and devices formed using such methods. However, it is to be understood that embodiments of the invention are not limited to the illustrative methods, apparatus, systems and devices but instead are more broadly applicable to other suitable methods, apparatus, systems and devices.

It is to be understood that the various features shown in the accompanying drawings are schematic illustrations that are not necessarily drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the terms “exemplary” and “illustrative” as used herein mean “serving as an example, instance, or illustration.” Any embodiment or design described herein as “exemplary” or “illustrative” is not to be construed as preferred or advantageous over other embodiments or designs.

As discussed above, co-packaged optics (CPO) techniques may be leveraged for implementing photonics applications, where a CPO structure is formed by co-fabricating optoelectronic or photonic devices together with complementary metal-oxide-semiconductor (CMOS) or other semiconductor integrated circuits to provide photonics systems.

Silicon-based photonics devices use optical fibers and waveguides (e.g., planar waveguides) to transmit information between devices. Optical connectors, also referred to herein as connectors, may be used to couple wafers or other semiconductor substrates to optical fibers. When optical signals are to be transmitted to silicon-based photonics devices, the optical signals that are inputted to and outputted from the silicon-based photonics device are typically coupled to one or more optical waveguide bundles providing optical wiring. An optical coupling between a silicon wafer and a planar optical waveguide may utilize a waveguide bundle that is optically coupled (e.g., using an adiabatic optical coupling mechanism) to a coupling area formed on a side of a silicon-based photonics device using the planar optical waveguide, where an end of the planar optical waveguide is held by an optical connector. The optical connector holds the planar optical waveguide and is optically coupled to an input/output (IO) port of the silicon-based photonics device.

Optical connectors used for holding waveguides (e.g., optical waveguides) coupled to silicon-based photonics devices may include a connector body (also referred to herein as a ferrule), one or more waveguides (e.g., polymer optical waveguides (POWs), glass optical waveguides (GOWs), combinations thereof, etc.) positioned in a U-shaped groove or other waveguide opening of the ferrule, and a lid placed over the waveguides positioned in the U-shaped groove or other waveguide opening of the ferrule. The ferrule is typically formed of a polymer material. If the waveguides are POWs, then the lid is formed of a glass material to provide rigidity to the optical connector structure. If the waveguides are GOWs, then the lid may be formed of a polymer material. In such optical connector assemblies, the ferrule edge typically overlaps with that of the lid.

In cases where the waveguides are POWs and the lid is glass, this causes stress to be concentrated on the POWs at the edge of the ferrule and lid. This stress concentration can cause rupture of the POWs (e.g., some POWs may be broken at the edge of the glass lid in the optical connector assembly process). This stress concentration at the POW-to-glass lid interface is due at least in part to the mismatch of thermal expansion coefficients of the polymer in the POW and the glass lid. Similar stress concentrations may result in cases where the waveguides are GOWs and the ferrule and lid are both polymer materials.

Illustrative embodiments provide techniques which are able to mitigate stress concentration for optical connector assemblies used for holding waveguides for coupling to silicon-based photonics devices. In some embodiments, stress concentrations are mitigated through displacement of stress concentration points on the top and bottom sides of waveguides that are proximate to edges of the ferrule and the lid. This may be achieved through recessing the edge of the lid (e.g., such that there is a gap between the edge of the lid and the edge of the ferrule) and/or adding a protrusion to the ferrule (e.g., such that the edge of the ferrule protrusion extends past the edge of the lid). In other embodiments, the stress concentrations are mitigated through introduction of a support structure at the edge of the lid connecting the lid edge and a surface of the optical waveguide.

In some embodiments, the stress concentration positions in optical connector assemblies (e.g., stress concentrations at the edge of the lid on both top and bottom sides of waveguides) are changed by adjusting a size of the lid used in the optical connector assembly or making a ferrule protrusion. To mitigate stress concentration, a gap between the edge of the lid and the edge of the ferrule at which the waveguides are inserted is changed (e.g., through recessing the lid edge relative to the edge of the ferrule, adding a protrusion on the ferrule which extends past the edge of the lid, combinations thereof, etc.). This gap may be adjustable in size, though in some embodiments the gap is less than 0.3 millimeters (mm) to mitigate the stress concentration points.

In other embodiments, the introduction of a support structure enables the stress concentration to be mitigated. The support structure is disposed at an interface of the waveguides and the lid of the optical connector assembly. The support structure may include edge supports (e.g., formed on edges of the waveguides proximate the edge of the ferrule and lid) and a “top” or “upper” support formed over the top or upper surface of the optical waveguide that extends across the width of the optical waveguide (e.g., between the edge supports), and which abuts the edge of the lid. The support structure may be formed of a material with appropriate material properties as described herein, and may be different than the optical adhesive which adheres an optical waveguide to a connector. The support structure thickness may be larger than half the thickness of the lid (e.g., for a glass lid that is 0.74 mm thick, the support structure thickness may be greater than 0.3 mm). The coefficient of thermal expansion (CTE) and modulus of the support structure is selected to be between those of the lid and the optical waveguide. For example, where the lid is formed of glass having a CTE of 3.2 parts per million per degree Kelvin (ppm/K) and the ferrule is formed of a polymer with a CTE of 103 ppm/K, the CTE of the support structure may be about 8 ppm/K. Where the lid is formed of glass with a modulus of about 70 gigapascals (GPa) and the ferrule is formed of a polymer with a modulus of about 6 GPa, the modulus of the support structure may be about 17 GPa. Various other examples are possible.

Advantageously, illustrative embodiments change the positions of and reduce stress concentration on the top and bottom surfaces of planar waveguides which are inserted into optical connectors (e.g., into a U-shaped groove or other waveguide opening in a ferrule over which a lid is placed), to prevent the waveguides from breaking during the assembly process. In some embodiments, an approximate 0.3 mm displacement of the lid is effective for mitigating the stress concentration for a POW inserted into a polymer ferrule which utilizes a glass lid. Advantageously, such an approach does not require any process changes other than changing the size of the glass lid (e.g., during the cutting process). In other embodiments, a ferrule protrusion is added (e.g., with a similar width of approximately 0.3 mm), which is effective for mitigating the stress concentration for a POW inserted into a polymer ferrule which utilizes a glass lid. Advantageously, such an approach does not require any process changes other than adjusting the mold shape used for forming the ferrule. In other embodiments, a support structure is added (e.g., in the form of a resin, epoxy and/or ultraviolet (UV) adhesive) that is dispensed and cured over a top surface of the optical waveguide abutting the edge of the lid. Advantageously, such an approach does not require any process changes other than dispensing and curing the resin used for the support structure.

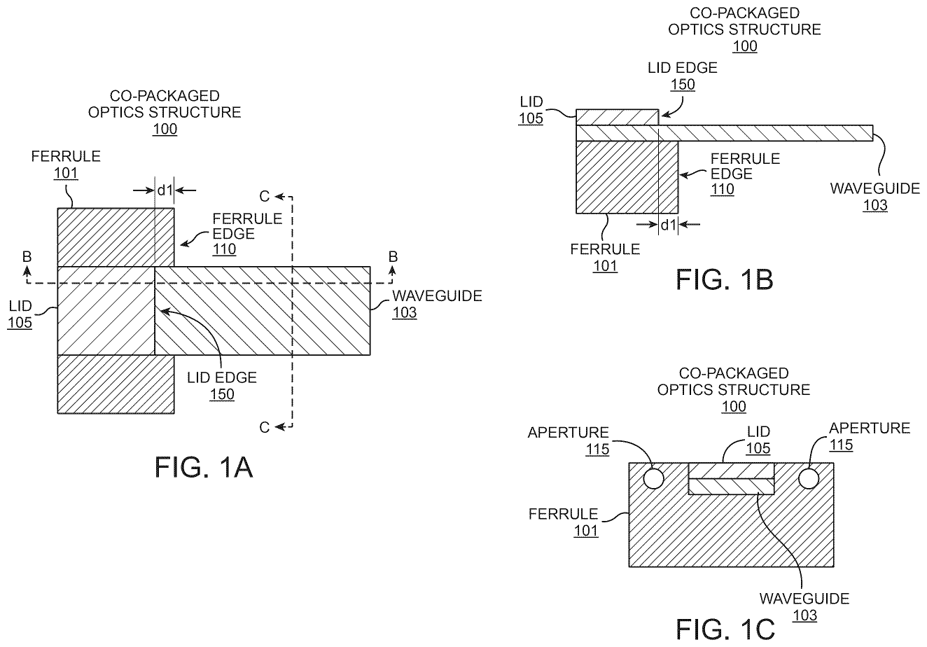

FIGS. 1A-1C show views of a CPO structure 100 including an optical connector assembly with a ferrule 101 having a waveguide opening in the form of a U-shaped groove, a waveguide 103 inserted into the waveguide opening of the ferrule 101, and a lid 105 placed over a portion of the waveguide 103. FIG. 1A shows a top-down view of the CPO structure 100, while FIG. 1B shows a first side view of the CPO structure 100 taken along the line B-B shown in FIG. 1A and FIG. 1C shows a second side view of the CPO structure 100 taken along the line C-C shown in FIG. 1A. As illustrated in FIGS. 1A and 1B, the ferrule 101 has a ferrule edge 110 while the lid 105 has a lid edge 150, with the lid edge 150 being recessed relative to the ferrule edge 110 by a distance d1, where d1 is approximately 4 t, where t is the thickness of the waveguide 103. For example, if the waveguide 103 has a thickness t of about 0.1 millimeters (mm), the distance d1 may be about 0.3 mm. As illustrated in FIG. 1C, the ferrule 101 also includes apertures 115 in side walls thereof, through which fixing members such as screws or metal rods are passed to align the position of the waveguide 103 with the optical connector assembly to connect it to an optical fiber. In some embodiments, the ferrule 101 is formed of a polymer material (e.g., polyphenylene sulfide (PPS), polyvinyl butyral, polyvinyl alcohol, an acrylic resin, etc.), while the waveguide 103 is a POW and the lid 105 is formed of a glass material (e.g., aluminosilicate glass, a silicate glass such as silicon dioxide, alkaline earth boro-aluminosilicate, soda-lime glass or sodium carbonate, etc.) providing rigidity of the overall optical connector assembly. In other embodiments, the waveguide 103 is a GOW and both the ferrule 101 and the lid 105 are formed of a polymer material (although the ferrule 101 and the lid 105 may be formed of different polymer materials if desired). The ferrule 101 may also be formed of a metal material, a ceramic material, silicon, glass, etc.

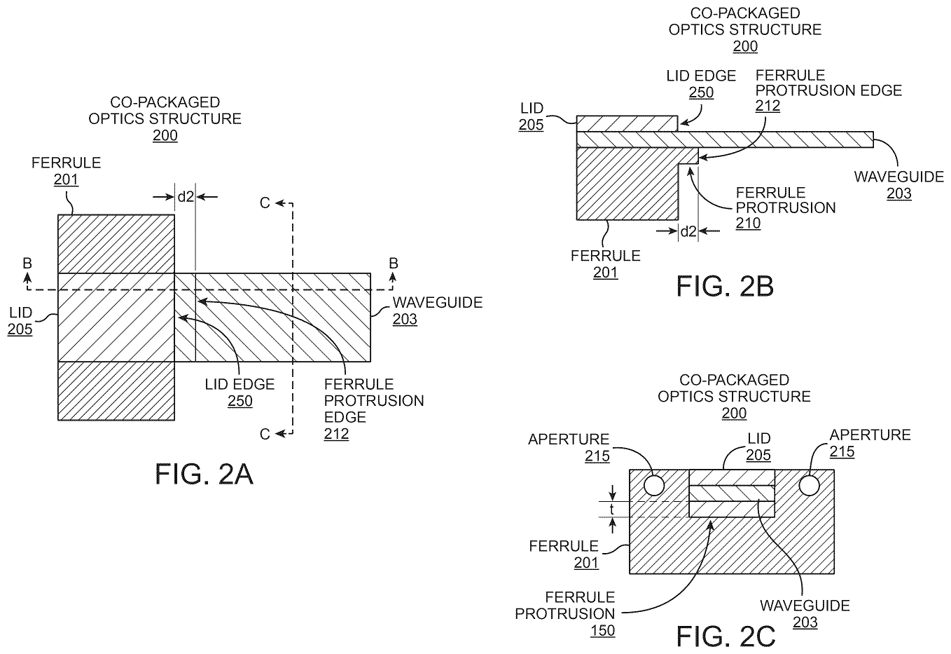

FIGS. 2A-2C show views of a CPO structure 200 including an optical connector assembly with a ferrule 201 having a waveguide opening in the form of a U-shaped groove, a waveguide 203 inserted into the waveguide opening of the ferrule 201, and a lid 205 placed over a portion of the waveguide 203. FIG. 2A shows a top-down view of the CPO structure 200, while FIG. 2B shows a first side view of the CPO structure 200 taken along the line B-B shown in FIG. 2A and FIG. 2C shows a second side view of the CPO structure 200 taken along the line C-C shown in FIG. 2A. As illustrated in FIGS. 2A and 2B, the ferrule 201 has a ferrule protrusion 210 with a ferrule protrusion edge 212 that extends past a lid edge 250 of the lid 205, where the length of the ferrule protrusion 210 is represented by a distance d2 between the lid edge 250 and the ferrule protrusion edge 212. The distance d2, similar to d1, may be approximately 4 t, where t is the thickness of the waveguide 203. As illustrated in FIG. 2C, the ferrule 201 also includes apertures 215 in side walls thereof, through which fixing members such as screws or metal rods are passed to align the position of the waveguide 103 with the optical connector assembly to connect it to an optical fiber. The ferrule protrusion 210 has a thickness p in the range of about 0.4 t, where t is the thickness of the waveguide 203. For example, if the waveguide 203 has a thickness t of about 0.1 mm, the protrusion thickness p may be about 0.04 mm. In some embodiments, the ferrule 201 is formed of a polymer material similar to those described above with respect to ferrule 101, while the waveguide 203 is a POW and the lid 205 is formed of a glass material similar to those described above with respect to lid 105, the lid 205 providing rigidity of the overall connector assembly. In other embodiments, the waveguide 203 is a GOW and both the ferrule 201 and the lid 205 are formed of a polymer material (although the ferrule 201 and the lid 205 may be formed of different polymer materials if desired).

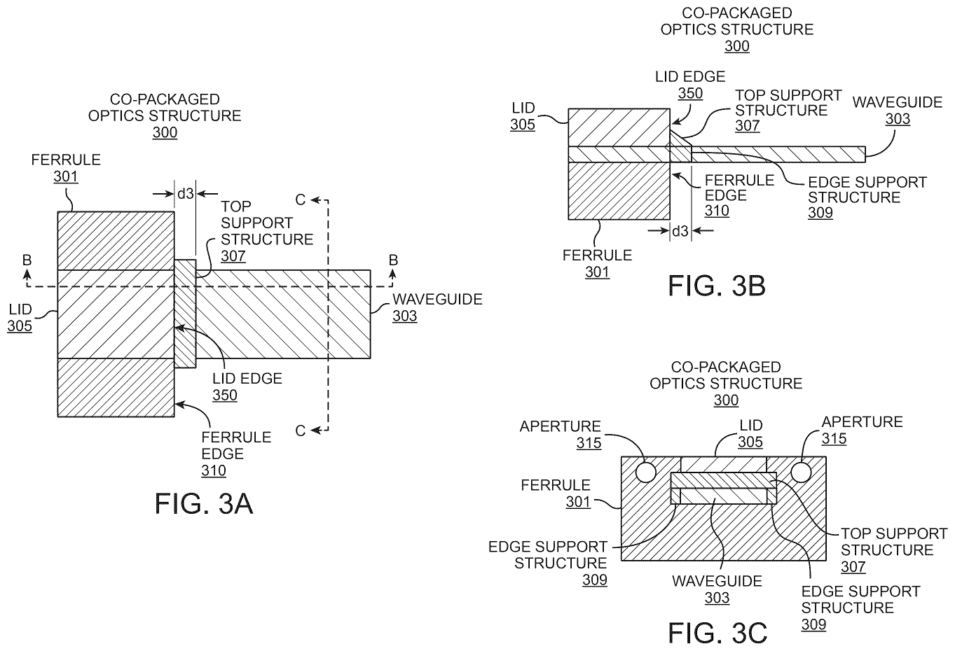

FIGS. 3A-3C show views of a CPO structure 300 including a connector assembly with a ferrule 301 having a waveguide opening in the form of a U-shaped groove, a waveguide 303 inserted into the waveguide opening of the ferrule 301, and a lid 305 placed over a portion of the waveguide 303. FIG. 3A shows a top-down view of the CPO structure 300, while FIG. 3B shows a first side view of the CPO structure 300 taken along the line B-B shown in FIG. 3A and FIG. 3C shows a second side view of the CPO structure 300 taken along the line C-C shown in FIG. 3A. As illustrated in FIGS. 3A-3C, a top support structure 307 and edge support structures 309 are formed around the waveguide 302 extending and abutting a lid edge 350 of lid 305 and a ferrule edge 310 of ferrule 301. The top support structure 307 and edge support structures 309 may be formed of an epoxy or other type of resin material such as glycidylamine epoxy resin, epoxy resin diluents, aliphatic epoxy resin, cycloaliphatic epoxy resin, bisphenol epoxy resin, novolac epoxy resin, etc., an UV adhesive such as an acrylic based adhesive, a polyurethane adhesive, a polyimide adhesive, a silicone-base adhesive, a fluorinated-base adhesive, combinations thereof, etc. In some embodiments, the top support structure 307 and the edge supports structures are formed of the same material. In other embodiments, the top support structure 307 is formed of a first material and the edge support structures 309 are formed of a second, different material. The width of the top support structure 307 is represented as a distance d3 extending past the ferrule edge 310 and the lid edge 350 (e.g., where d3 is greater than half the thickness of the lid 305). It should be noted that the edge support structures 309 are optional, and that in some embodiments only the top support structure 307 is formed. As illustrated in FIG. 3C, the ferrule 301 also includes apertures 315 in side walls thereof, through which fixing members such as screws or metal rods are passed to align the position of the waveguide 103 with the optical connector assembly to connect it to an optical fiber. In some embodiments, the ferrule 301 is formed of a polymer material similar to those described above with respect to ferrule 101, while the waveguide 303 is a POW and the lid 305 is formed of a glass material similar to those described above with respect to lid 105, the lid 305 providing rigidity of the overall connector assembly. In other embodiments, the waveguide 303 is a GOW and both the ferrule 301 and the lid 305 are formed of a polymer material (although the ferrule 201 and the lid 205 may be formed of different polymer materials if desired). The top support structure 307 and the edge support structures 309 may be formed of a polymer with a CTE and modulus between those of the waveguide 303 and the lid 305.

Although not shown, in some embodiments the approaches illustrated in FIGS. 1A-1C, 2A-2C and 3A-3C may be combined. For example, a CPO structure may include an optical connector assembly where the edge of the lid is recessed (e.g., as illustrated in FIGS. 1A-1C) and where the ferrule includes a protrusion (e.g., as illustrated in FIGS. 2A-2C). As another example, a CPO structure may include an optical connector assembly where the edge of the lid is recessed (e.g., as illustrated in FIGS. 1A-1C) and/or where the ferrule includes a protrusion (e.g., as illustrated in FIGS. 2A-2C), and where the optical connector assembly also includes a support structure including edge and/or top support structures (e.g., as illustrated in FIGS. 3A-3C).

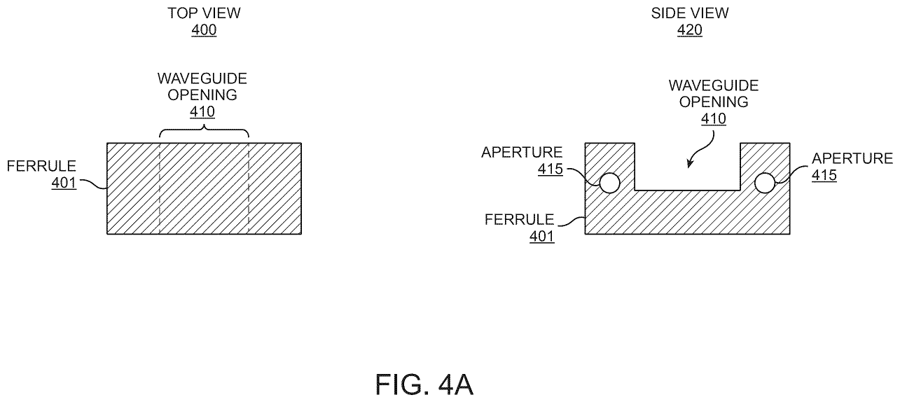

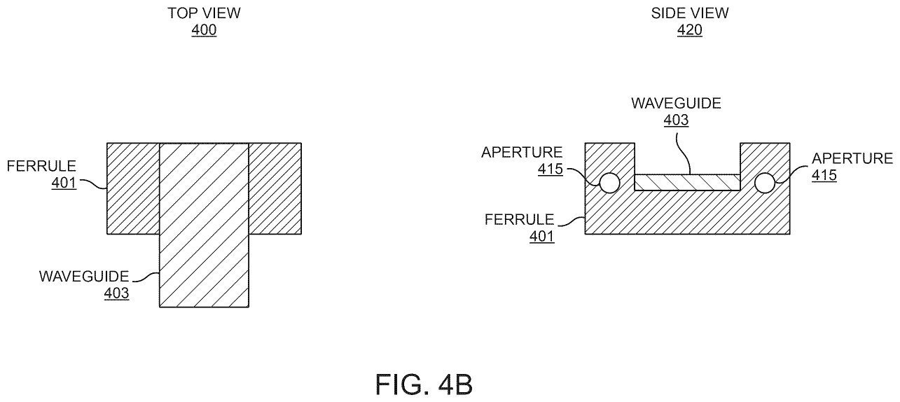

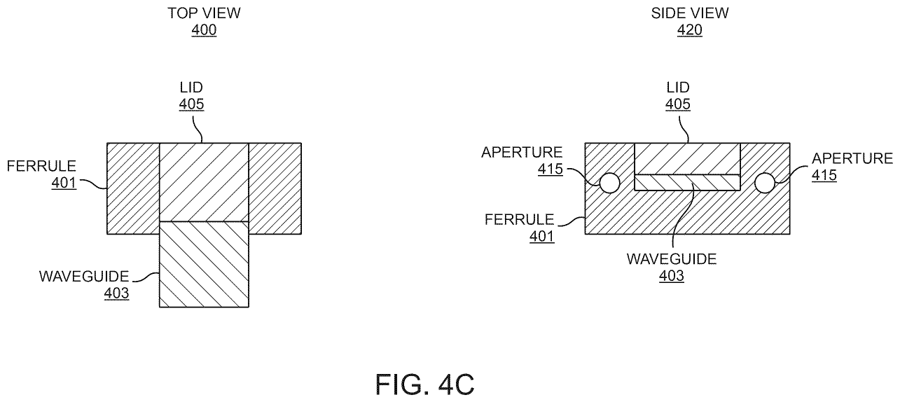

FIGS. 4A-4C show a process flow for assembly of an optical connector structure similar to that shown in FIGS. 1A-1C. Each of FIGS. 4A-4C includes a top view 400 and a side view 420. As shown in FIG. 4A, a ferrule 401 is provided having a waveguide opening 410 (e.g., a U-shaped opening) and apertures 415 similar to apertures 115 described above. As shown in FIG. 4B, a waveguide 403 (e.g., a POW or GOW) is placed over the waveguide opening 410 in the ferrule 401 by passive alignment. As shown in FIG. 4C, a lid 405 is placed over the waveguide 403, where the lid 405 has an edge that is recessed relative to the edge of the ferrule 401. In some embodiments, the ferrule 401 is a polymer material, the waveguide 403 is a POW, and the lid 405 is a glass lid. In other cases, the ferrule 401 is a polymer material, the waveguide 403 is a GOW, and the lid 405 is a polymer material. An adhesive (e.g., an acrylic based adhesive, polyurethane adhesives, polyimide adhesives, etc.) may be placed between the ferrule 401 and the waveguide 403, and between the waveguide 403 and the lid 405. The adhesive may be cured (e.g., using UV light) while applying pressure on the lid 405. The facet of the optical connector assembly may then be polished. A similar process flow may be used for forming the structure shown in FIGS. 2A-2C, though in that case the ferrule 401 would include a protrusion and the lid 405 may (but is not required to) have a recessed edge.

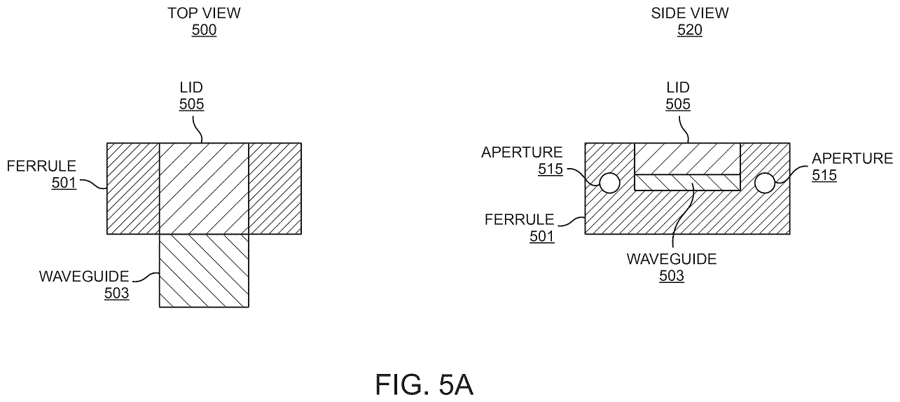

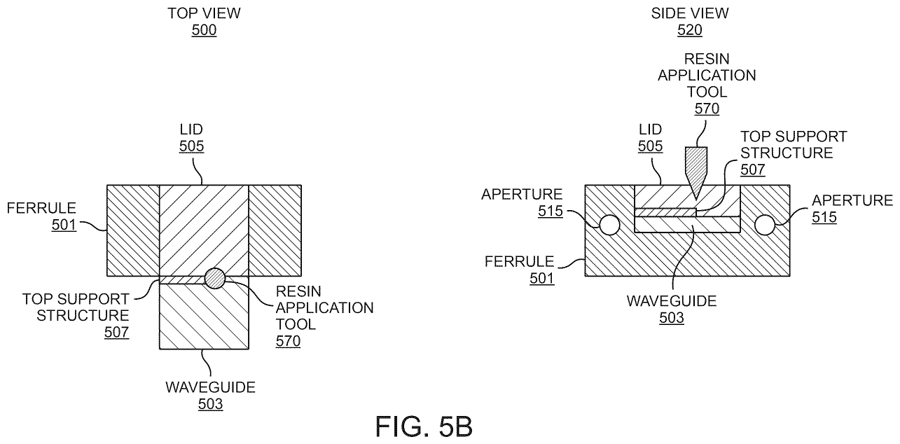

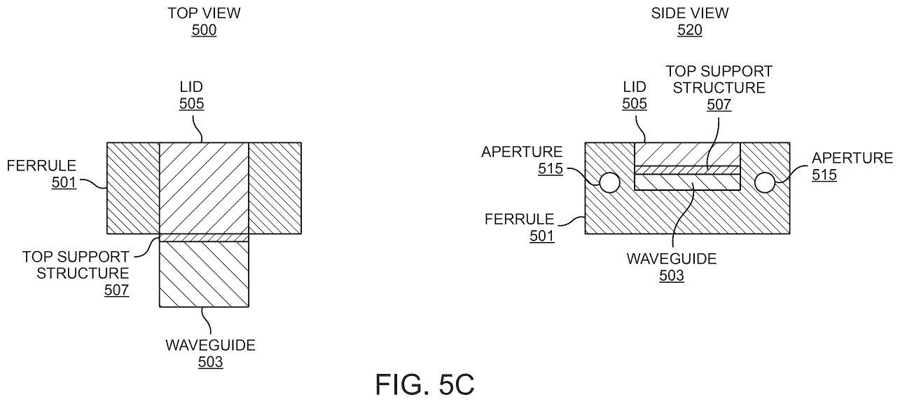

FIGS. 5A-5C show a process flow for assembly of an optical connector structure similar to that shown in FIGS. 3A-3C. Each of FIGS. 5A-5C includes a top view 500 and a side view 520. As shown in FIG. 5A, a ferrule 501 is provided having a waveguide opening (e.g., a U-shaped opening) over which a waveguide 503 and a lid 505 are placed. As shown in FIG. 5B, a resin application tool 570 is used to apply a top support structure 507 over a top surface of the waveguide 503 proximate the edge of the lid 505. FIG. 5C shows the structure following application of the top support structure 507 across an entire width of the waveguide 503.

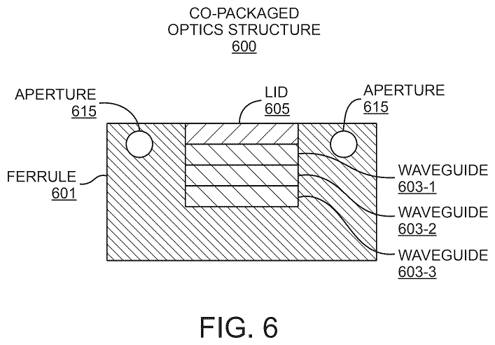

FIG. 6 shows a side view of a CPO structure 600, which is similar to the CPO structure 100 shown in FIGS. 1A-1C but which includes stacked waveguides 603-1, 603-2 and 603-3 (collectively, waveguides 603) rather than a single waveguide 103. The CPO structure 600 includes a ferrule 601 with apertures 615 and a lid 605, which are similar to the ferrule 101, apertures 115 and lid 105.

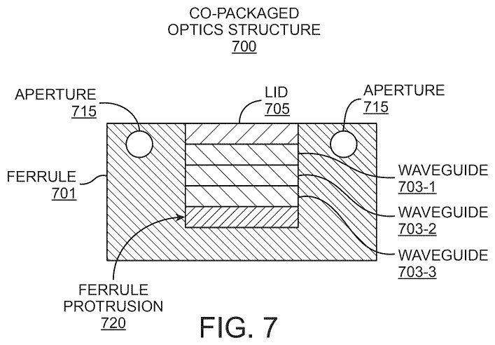

FIG. 7 shows a side view of a CPO structure 700, which is similar to the CPO structure 200 shown in FIGS. 2A-2C but which includes stacked waveguides 703-1, 703-2 and 703-3 (collectively, waveguides 703) rather than a single waveguide 203. The CPO structure 700 includes a ferrule 701 with apertures 715 and a ferrule protrusion 720 along with a lid 705, which are similar to the ferrule 201, apertures 215, ferrule protrusion 220 and lid 205.

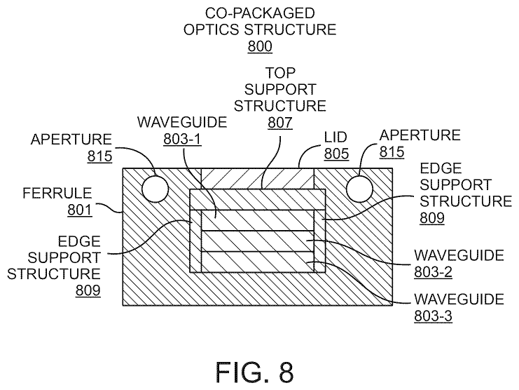

FIG. 8 shows a side view of a CPO structure 800, which is similar to the CPO structure 300 shown in FIGS. 3A-3C but which includes stacked waveguides 803-1, 803-2 and 803-3 (collectively, waveguides 803) rather than a single waveguide 303. The CPO structure 800 includes a ferrule 801 with apertures 815, lid 805, top support structure 807 and edge support structure 809, which are similar to the ferrule 301, apertures 315, lid 305, top support structure 307 and edge support structure 809.

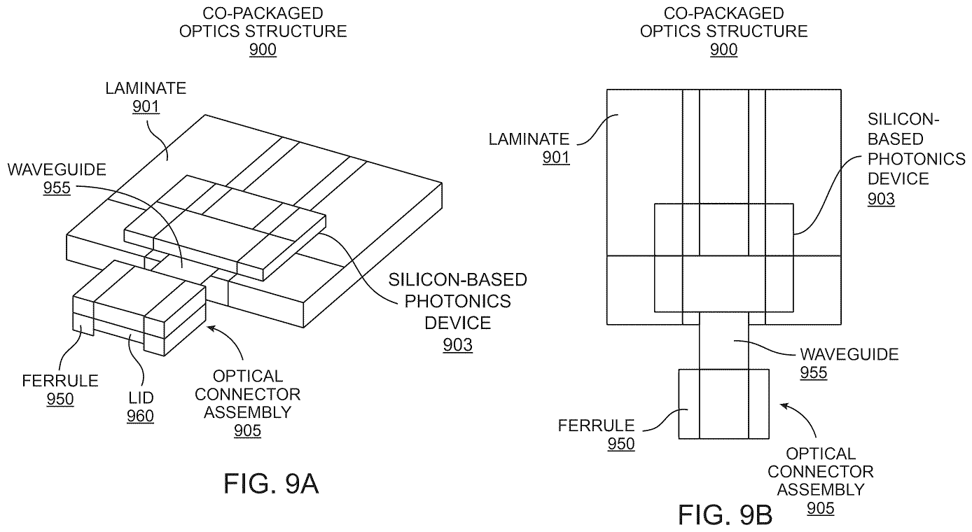

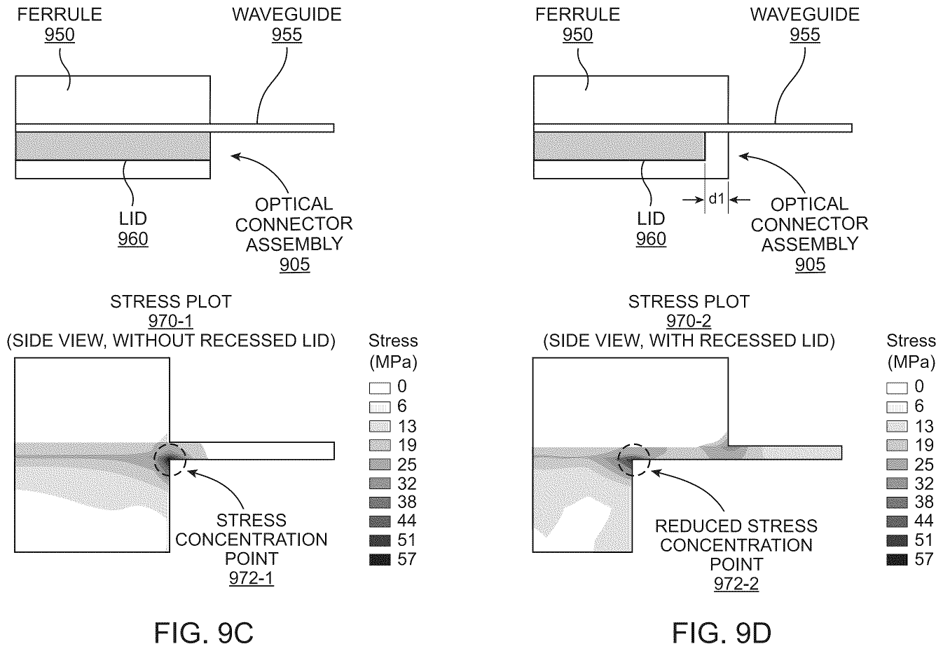

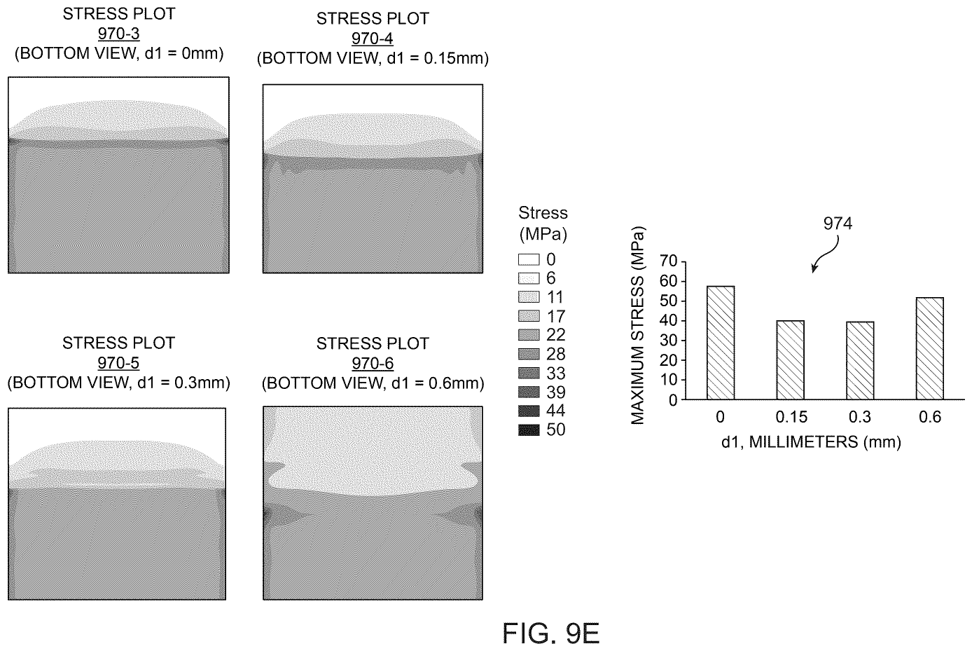

FIGS. 9A-9D show aspects of a CPO structure 900. FIG. 9A shows a perspective view of the CPO structure 900, including a laminate 901 on which a silicon-based photonics device 903 is placed, along with an optical connector assembly 905 including a ferrule 950, a waveguide 955 and a lid 960, where the optical connector assembly 905 couples the waveguide 955 to the silicon-based photonics device 903. Here, the ferrule 950 may have a Young's modulus of about 6 GPa and a CTE of about 30 ppm/K, while the lid 960 may be a glass lid with a Young's modulus of about 70 GPa and a CTE of about 3.2 ppm/K. FIG. 9B shows a top view of the CPO structure 900. FIG. 9C shows a side view of the optical connector assembly 905 where the lid 960 does not have a recessed edge, along with a stress plot 970-1 for this structure showing stress concentration include a high stress point 972-1 at the edge of the lid 960. FIG. 9D shows a side view of the optical connector assembly 905 where the lid 960 does include a recessed edge (e.g., recessed by the distance d1), along with a stress plot 970-2 for this structure showing reduced stress concentration point 972-2 at the edge of the recessed lid 960. The offset or recess of the edge of the lid 960 from the edge of the ferrule 950 allows stress to be more distributed, reducing the risk of failure. FIG. 9E shows a set of stress plots 970-3 through 970-6 of bottom views of the optical connector assembly 905 for varying values of d1, ranging from 0 (no recess) to 0.6 mm, along with a chart 974 illustrating the maximum stress (in megapascals, MPa) as a function of the distance d1.

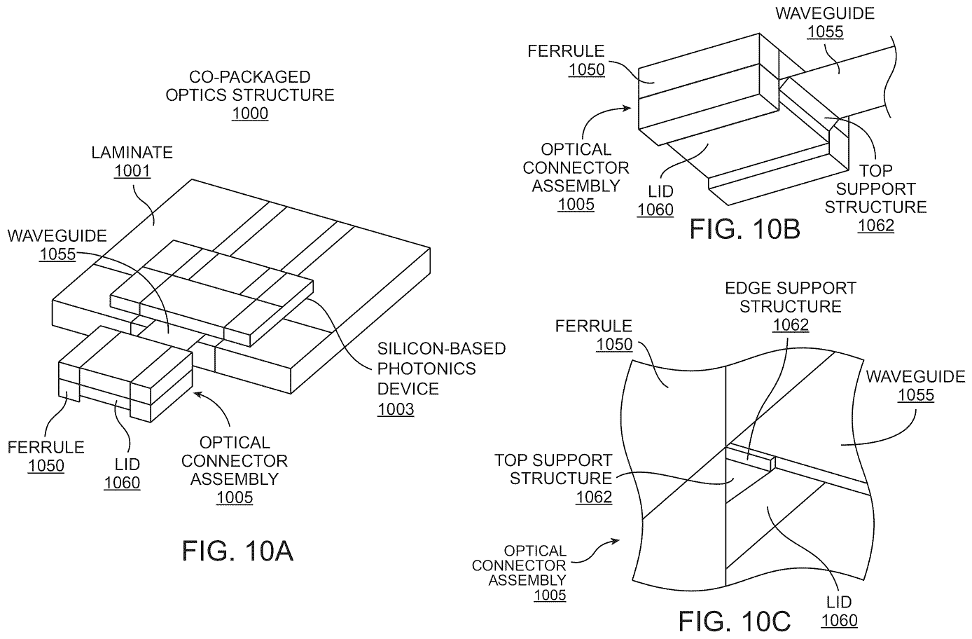

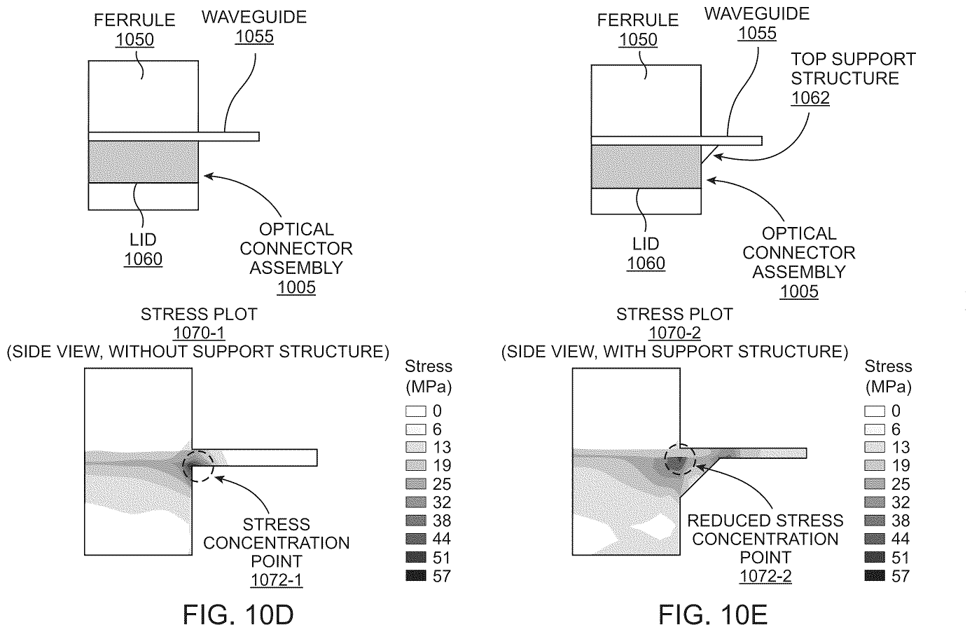

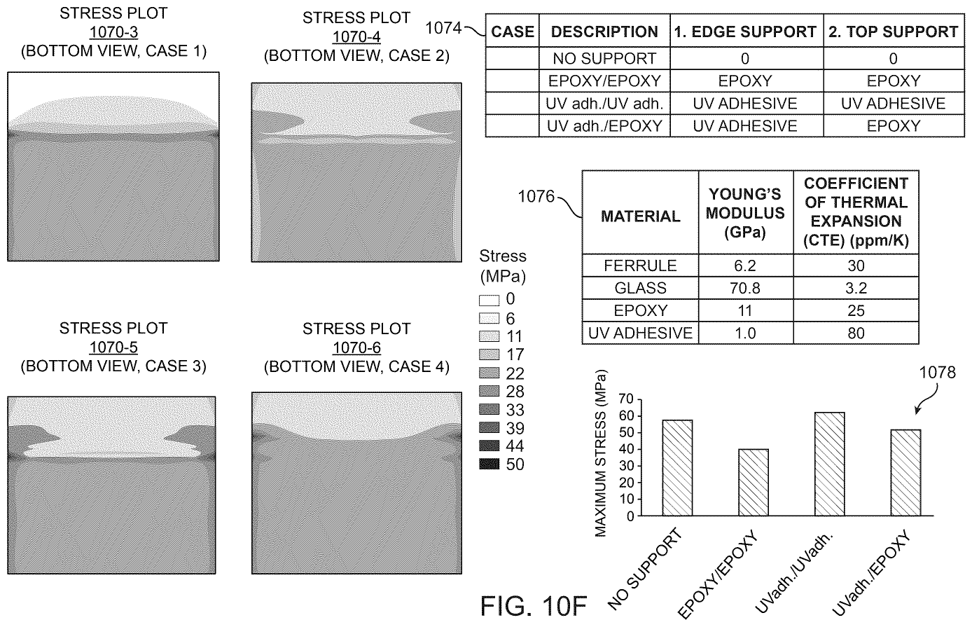

FIGS. 10A-10F show aspects of a CPO structure 1000. FIGS. 10A-10C show different perspective views of the CPO structure 1000, including a laminate 1001 on which a silicon-based photonics device 1003 is placed, along with an optical connector assembly 1005 including a ferrule 1050, a waveguide 1055, a lid 1060, a top support structure 1062 and edge support structure 1064. FIG. 10D shows a side view of the optical connector assembly 1005 without the top support structure 1062 and the edge support structure 1064, along with a stress plot 1070-1 for this structure showing stress concentration include a high stress point 1072-1 at the edge of the lid 1060. FIG. 10E shows a side view of the optical connector assembly 1005 including the top support structure 1062, along with a stress plot 1070-2 for this structure showing reduced stress concentration point 1072-2 at the edge of the lid 1060. The top support structure 1062 (as well as the edge support structure 1064) relieve some of the stress at the interface (e.g., of the waveguide 1055 and the lid 1060/ferrule 1050), reducing the risk of failure. FIG. 10F shows a set of stress plots 1070-3 through 1070-6 of bottom views of the optical connector assembly 1005 for varying cases including combinations of different materials for the top support structure 1062 and edge support structure 1064, including a first case (Case 1) without either the top support structure 1062 or the edge support structure 1064, a second case (Case 2) with both the top support structure 1062 and the edge support structure 1064 being formed of an epoxy, a third case (Case 3) with both the top support structure 1062 and the edge support structure 1064 being formed of a UV adhesive, and a fourth case (Case 4) where the top support structure 1062 is an epoxy and the edge support structure 1064 is a UV adhesive. FIG. 10F shows a table 1074 detailing these combinations of support structures for Cases 1-4, as well as a table 1076 of the Young's modulus and CTE for the ferrule 1050, the lid 1060 (formed of glass), the epoxy and the UV adhesive. FIG. 10F further shows a chart 1078 illustrating the maximum (in megapascals, MPa) for each of the Cases 1-4.

It should be noted that the pull strength of the waveguide 1055 in the optical connector assembly 1005 is affected by applying reflow for forming the top support structure 1062 and the edge support structure 1064. Further, the elongation rate of the waveguide 1055 after the reflow is approximately half that of a non-reflow sample.

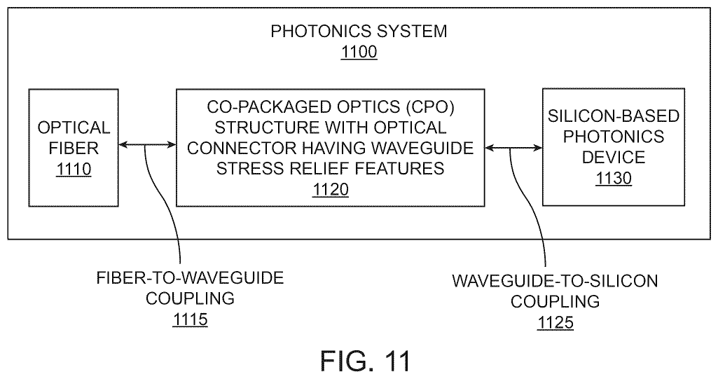

FIG. 11 shows a photonics system 1100 which includes an optical fiber 1110 coupled via fiber-to-waveguide coupling 1115 to a CPO structure 1120 with an optical connector having waveguide stress relief features, which is coupled via waveguide-to-silicon coupling 1125 to a silicon-based photonics device 1130. The CPO structure 1120 may be configured as described above with respect to any of CPO structures 100, 200, 300, 600, 700, 800, 900 or 1000.

According to an aspect of the invention, a connector structure for coupling optical signals to a semiconductor device includes a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, and a lid positioned over the optical waveguide structure, the lid securing the optical waveguide structure in the recessed portion of the connector body, the lid having a first edge and a second edge, the first edge of the lid being proximate to the first side of the connector body, the second edge of the lid being offset from an edge at the second side of the connector body.

In embodiments, the second edge of the lid is recessed away from the second side of the connector body towards the first side of the connector body. The second edge of the lid may be recessed away from the second side of the connector body by a distance that is approximately four times a thickness of the optical waveguide structure.

In embodiments, the connector body comprises a protrusion disposed on the second side of the connector body below the recessed portion of the connector body where the optical waveguide structure is positioned, and wherein the edge at the second side of the connector body is an edge of the protrusion. The protrusion may have a length that is approximately four times a thickness of the optical waveguide structure. The second edge of the lid may be offset from the edge at the second side of the connector body by a length of the protrusion.

In embodiments, the connector body is a mechanical transfer (MT) ferrule. The optical waveguide structure may be a polymer ribbon and the one or more waveguides may be POWs, and the lid may be a glass lid. The optical waveguide structure may be a glass waveguide structure and the one or more waveguides may be GOWs, and the lid may be part of the MT ferrule.

In embodiments, the optical waveguide structure includes a multi-layered stack structure including two or more waveguides stacked over one another.

According to an aspect of the invention, a connector structure for coupling optical signals to a semiconductor device includes a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, a lid positioned over the optical waveguide structure, the lid securing the optical waveguide structure in the recessed portion of the connector body, the lid having a first edge and a second edge, the first edge of the lid being proximate to the first side of the connector body, the second edge of the lid being proximate to the second side of the connector body, and a support structure attached along an intersection line of the optical waveguide structure and the second edge of the lid.

In embodiments, the support structure is an epoxy material.

In embodiments, the support structure is an UV adhesive.

In embodiments, the lid has a first thickness and the support structure has a second thickness, the second thickness being greater than half the first thickness.

In embodiments, the connector body is an MT ferrule, the optical waveguide structure is a polymer ribbon and the one or more waveguides are POWs, and the lid is a glass lid. The polymer ribbon may have a first coefficient of thermal expansion and a first Young's modulus, the glass lid may have a second coefficient of thermal expansion and a second Young's modulus, and the support structure may have a third coefficient of thermal expansion and a third Young's modulus, the third coefficient of thermal expansion being between the first coefficient of thermal expansion and the second coefficient of thermal expansion, the third Young's modulus being between the first Young's modulus and the second Young's modulus.

According to an aspect of the invention, a CPO structure includes a semiconductor device having an optical IO port and a connector structure coupling an optical waveguide structure to the optical IO port of the semiconductor device, the connector structure including a connector body comprising a recessed portion extending from a first side of the connector body to a second side of the connector body, an optical waveguide structure comprising one or more waveguides, the optical waveguide structure being positioned in the recessed portion of the connector body and extending from the first side of the connector body and out through the second side of the connector body, and a lid positioned over the optical waveguide structure, the lid securing the optical waveguide structure in the recessed portion of the connector body. At least one of: the lid has a first edge and a second edge, the first edge of the lid being proximate to the first side of the connector body, the second edge of the lid being offset from an edge at the second side of the connector body; and the connector structure further comprises a support structure attached along an intersection line of the optical waveguide structure and the second edge of the lid.

In embodiments, the second edge of the lid is recessed away from the second side of the connector body towards the first side of the connector body.

In embodiments, the connector body comprises a protrusion disposed on the second side of the connector body below the recessed portion of the connector body where the optical waveguide structure is positioned, and wherein the edge at the second side of the connector body is an edge of the protrusion.

In embodiments, the connector body is an MT ferrule, the optical waveguide structure is a polymer ribbon and the one or more waveguides are POWs, and the lid is a glass lid.

Semiconductor devices and methods for forming the same in accordance with the above-described techniques can be employed in various applications, hardware, and/or electronic systems. Suitable hardware and systems for implementing embodiments of the invention may include, but are not limited to, personal computers, communication networks, electronic commerce systems, portable communications devices (e.g., cell and smart phones), solid-state media storage devices, functional circuitry, etc. Systems and hardware incorporating the semiconductor devices are contemplated embodiments of the invention. Given the teachings provided herein, one of ordinary skill in the art will be able to contemplate other implementations and applications of embodiments of the invention.

In some embodiments, the above-described techniques are used in connection with semiconductor devices that may require or otherwise utilize, for example, complementary metal-oxide-semiconductor (CMOS) transistors, metal-oxide-semiconductor field-effect transistors (MOSFETs), and/or FinFETs. By way of non-limiting example, the semiconductor devices can include, but are not limited to CMOS, MOSFET, and FinFET devices, and/or semiconductor devices that use CMOS, MOSFET, and/or FinFET technology.

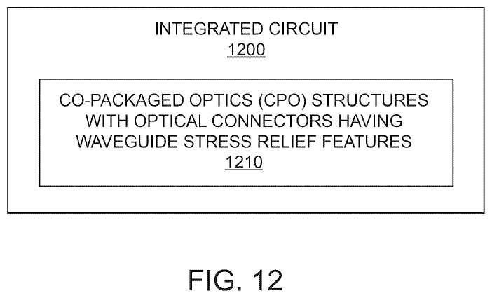

Various structures described above may be implemented in integrated circuits. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher-level carrier) or in a multichip package (such as a ceramic carrier that has either or both surface interconnections or buried interconnections). In any case the chip is then integrated with other chips, discrete circuit elements, and/or other signal processing devices as part of either: (a) an intermediate product, such as a motherboard, or (b) an end product. The end product can be any product that includes integrated circuit chips, ranging from toys and other low-end applications to advanced computer products having a display, a keyboard or other input device, and a central processor. FIG. 12 shows an example integrated circuit 1200 which includes one or more co-packaged optics structures 1210 including optical connectors with waveguide stress relief features.

It should be understood that the various layers, structures, and regions shown in the figures are schematic illustrations that are not drawn to scale. In addition, for ease of explanation, one or more layers, structures, and regions of a type commonly used to form semiconductor devices or structures may not be explicitly shown in a given figure. This does not imply that any layers, structures, and regions not explicitly shown are omitted from the actual semiconductor structures. Furthermore, it is to be understood that the embodiments discussed herein are not limited to the particular materials, features, and processing steps shown and described herein. With respect to semiconductor processing steps, it is to be emphasized that the descriptions provided herein are not intended to encompass all of the processing steps that may be required to form a functional semiconductor integrated circuit device. Rather, certain processing steps that are commonly used in forming semiconductor devices, such as, for example, wet cleaning and annealing steps, are purposefully not described herein for economy of description.

Moreover, the same or similar reference numbers are used throughout the figures to denote the same or similar features, elements, or structures, and thus, a detailed explanation of the same or similar features, elements, or structures are not repeated for each of the figures. It is to be understood that the terms “approximately” or “substantially” as used herein with regard to thicknesses, widths, percentages, ranges, temperatures, times and other process parameters, etc., are meant to denote being close or approximate to, but not exactly. For example, the term “approximately” or “substantially” as used herein implies that a small margin of error is present, such as ±5%, preferably less than 2% or 1% or less than the stated amount.

In the description above, various materials, dimensions and processing parameters for different elements are provided. Unless otherwise noted, such materials are given by way of example only and embodiments are not limited solely to the specific examples given. Similarly, unless otherwise noted, all dimensions and process parameters are given by way of example and embodiments are not limited solely to the specific dimensions or ranges given.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A connector structure for coupling optical signals to a semiconductor device, the connector structure comprising:
a connector body comprising a recessed portion extending from a first side of the connector body to a second side of the connector body;
an optical waveguide structure comprising one or more waveguides, the optical waveguide structure being positioned in the recessed portion of the connector body and extending from the first side of the connector body and out through the second side of the connector body; and
a lid positioned over the optical waveguide structure, the lid securing the optical waveguide structure in the recessed portion of the connector body, the lid having a first edge and a second edge, the first edge of the lid being proximate to the first side of the connector body, the second edge of the lid being offset from an edge at the second side of the connector body.

2. The connector structure of claim 1, wherein the second edge of the lid is recessed away from the second side of the connector body towards the first side of the connector body.

3. The connector structure of claim 2, wherein the second edge of the lid is recessed away from the second side of the connector body by a distance that is approximately four times a thickness of the optical waveguide structure.

4. The connector structure of claim 1, wherein the connector body comprises a protrusion disposed on the second side of the connector body below the recessed portion of the connector body where the optical waveguide structure is positioned, and wherein the edge at the second side of the connector body is an edge of the protrusion.

5. The connector structure of claim 4, wherein the protrusion has a length that is approximately four times a thickness of the optical waveguide structure.

6. The connector structure of claim 4, wherein the second edge of the lid is offset from the edge at the second side of the connector body by a length of the protrusion.

7. The connector structure of claim 1, wherein the connector body is a mechanical transfer (MT) ferrule.

8. The connector structure of claim 7, wherein the optical waveguide structure is a polymer ribbon and the one or more waveguides comprise polymer optical waveguides, and wherein the lid is a glass lid.

9. The connector structure of claim 7, wherein the optical waveguide structure is a glass waveguide structure and the one or more waveguides comprise glass optical waveguides, and wherein the lid is part of the MT ferrule.

10. The connector structure of claim 1, wherein the optical waveguide structure comprises multi-layered stack structure including two or more waveguides stacked over one another.

11. A connector structure for coupling optical signals to a semiconductor device, the connector structure comprising:
a connector body comprising a recessed portion extending from a first side of the connector body to a second side of the connector body;
an optical waveguide structure comprising one or more waveguides, the optical waveguide structure being positioned in the recessed portion of the connector body and extending from the first side of the connector body and out through the second side of the connector body;
a lid positioned over the optical waveguide structure, the lid securing the optical waveguide structure in the recessed portion of the connector body, the lid having a first edge and a second edge, the first edge of the lid being proximate to the first side of the connector body, the second edge of the lid being proximate to the second side of the connector body; and
a support structure attached along an intersection line of the optical waveguide structure and the second edge of the lid.

12. The connector structure of claim 11, wherein the support structure comprises an epoxy material.

13. The connector structure of claim 11, wherein the support structure comprises an ultraviolet adhesive.

14. The connector structure of claim 11, wherein the lid has a first thickness, and wherein the support structure has a second thickness, the second thickness being greater than half the first thickness.

15. The connector structure of claim 11, wherein the connector body is a mechanical transfer (MT) ferrule, wherein the optical waveguide structure is a polymer ribbon and the one or more waveguides comprise polymer optical waveguides, and wherein the lid is a glass lid.

16. The connector structure of claim 15, wherein the polymer ribbon has a first coefficient of thermal expansion and a first Young's modulus, the glass lid has a second coefficient of thermal expansion and a second Young's modulus, and wherein the support structure has a third coefficient of thermal expansion and a third Young's modulus, the third coefficient of thermal expansion being between the first coefficient of thermal expansion and the second coefficient of thermal expansion, the third Young's modulus being between the first Young's modulus and the second Young's modulus.

17. A co-packaged optics structure comprising:
a semiconductor device having an optical input/output port; and
a connector structure coupling an optical waveguide structure to the optical input/output port of the semiconductor device, the connector structure comprising:
a connector body comprising a recessed portion extending from a first side of the connector body to a second side of the connector body;
an optical waveguide structure comprising one or more waveguides, the optical waveguide structure being positioned in the recessed portion of the connector body and extending from the first side of the connector body and out through the second side of the connector body; and
a lid positioned over the optical waveguide structure, the lid securing the optical waveguide structure in the recessed portion of the connector body;
wherein at least one of:
the lid has a first edge and a second edge, the first edge of the lid being proximate to the first side of the connector body, the second edge of the lid being offset from an edge at the second side of the connector body; and
the connector structure further comprises a support structure attached along an intersection line of the optical waveguide structure and the second edge of the lid.

18. The co-packaged optics structure of claim 17, wherein the second edge of the lid is recessed away from the second side of the connector body towards the first side of the connector body.

19. The co-packaged optics structure of claim 17, wherein the connector body comprises a protrusion disposed on the second side of the connector body below the recessed portion of the connector body where the optical waveguide structure is positioned, and wherein the edge at the second side of the connector body is an edge of the protrusion.

20. The co-packaged optics structure of claim 17, the connector body is a mechanical transfer (MT) ferrule, wherein the optical waveguide structure is a polymer ribbon and the one or more waveguides comprise polymer optical waveguides, and wherein the lid is a glass lid.
